(19) United States
(12) Patent Application Publication
(10) Pub. No.: US 2025/0278964 A1
(43) Pub. Date: Sep. 4, 2025

(54) SENSOR DATA PROCESSING METHOD, APPARATUS, ELECTRONIC DEVICE, AND STORAGE MEDIUM

(71) Applicant: SAIC GM Wuling Automobile Co., Ltd., Guangxi (CN)

(72) Inventors: Changye LIU, Liuzhou (CN); Caiyan CHEN, Liuzhou (CN); Li YANG, Liuzhou (CN); Min WEI, Liuzhou (CN); Bin LI, Liuzhou (CN)

(73) Assignee: SAIC GM Wuling Automobile Co., Ltd., Guangxi (CN)

(21) Appl. No.: 19/210,657

(22) Filed: May 16, 2025

Related U.S. Application Data
(63) Continuation of application No. PCT/CN2024/140587, filed on Dec. 19, 2024.

(30) Foreign Application Priority Data
Jan. 29, 2024 (CN) 202410122441.2

(51) Int. Cl. G07C 5/10; B62D 15/02; G06F 13/20

(52) U.S. Cl. CPC G07C 5/10; G06F 13/20; B62D 15/021; G06F 2213/40

(57) ABSTRACT

A sensor data processing method, apparatus, electronic device and storage medium are provided. The method includes: acquiring a sensor data set, determining N sensor input sampling values, and determining, based on each sensor input sampling value, a sensor output sampling value corresponding to the sensor input sampling value in the sensor data set, to obtain N sampling data. In the embodiments of the present disclosure, the sensor data processing apparatus acquires a sensor data set and determines N sensor input sampling values. In addition, the sensor data processing apparatus determines, based on each sensor input sampling value, the sensor output sampling value corresponding to the sensor input sampling value in the sensor data set, to obtain N sampling data. Such process does not involve complex manual operations, so that the final determined N sampling data have high accuracy, and the process of determining N sampling data is highly efficient.

### CROSS-REFERENCE TO RELATED DISCLOSURE

The present application is a bypass continuation application of International Patent Application No. PCT/CN2024/140587, filed on Dec. 19, 2024, which claims priority to Chinese Patent Application No. 202410122441.2, filed on Jan. 29, 2024, the contents of which are incorporated herein by reference in their entireties.

### TECHNICAL FIELD

The present disclosure relates to the field of sensor technologies, and in particular to a sensor data processing method, apparatus, electronic device, and storage medium.

### BACKGROUND

The sensor refers to a device that can be directly sense the measurand and output an electrical signal or other signal that has a certain relationship with the measurand. In the actual use of the vehicle, there are sensors that collect relevant signals for electric power steering system (EPS) of the vehicle. As one of the key devices of the electronic power steering system, the performance of the sensor directly determines the performance of the electronic power steering system, so it is necessary to perform relevant analysis on the performance of the sensor. In general, the performance of the sensor is analyzed according to a correspondence curve between the sensor input values and the sensor output values. In order to determine the correspondence curve between the sensor input values and the sensor output values, it is necessary to determine a corresponding data set of the sensor input values and the sensor output values.

In the related art, after the sensor output waveform and the sensor input waveform are received and related processing is performed on them, a sensor data set including a group of sensor output values and corresponding sensor input values can be determined. The sensor data set is organized to be stored in a table, and the sensor input values and their corresponding sensor output values are sorted. Next, N sensor input values and their corresponding sensor output values are evenly selected, and N sampling data are finally determined.

However, by organizing and the sensor data set into a table and sorting it, and manually selecting N sensor input values and their corresponding output values, the accuracy of the determined N sampling data may be low, and the process of determining the N sampling data may be inefficient.

It should be pointed out that the information disclosed in the background of the present disclosure is only intended to deepen the understanding of the general background technology of the present disclosure, and should not be regarded as an admission or any implication that the information constitutes prior art known to those skilled in the art.

### SUMMARY

In view of the above, the present disclosure provides a sensor data processing method, apparatus, electronic device, and storage medium, so as to solve the problem in the related art that organizing and sorting the sensor data set into a table and manually selecting N sensor input values and their corresponding output values may result in low accuracy of the determined N sampling data and low efficiency of the determination process of N sampling data.

In a first aspect, embodiments of the present disclosure provide a sensor data processing method. The sensor data processing method includes: acquiring a sensor data set, where the sensor data set including M pieces of sensor data, each of which includes a sensor input value and a sensor output value; determining N sensor input sampling values, where M>N>1; and determining, based on each of the N sensor input sampling values, a sensor output sampling value corresponding to the sensor input sampling value in the sensor data set, to obtain N sampling data, where the sensor output sampling value is the sensor output value corresponding to the sensor input value adjacent to the sensor input sampling value in the sensor data set.

In one or more embodiments, subsequent to acquiring the sensor data set, the sensor data processing method further includes: determining, from the sensor data set, forward stroke sensor data and reverse stroke sensor data.

In one or more embodiments, the determining, from the sensor data set, forward stroke sensor data and reverse stroke sensor data includes: determining, from the sensor data set, the forward stroke sensor data and the reverse stroke sensor data in the sensor data set based on a change trend of sensor output values.

In one or more embodiments, the determining, from the sensor data set, the forward stroke sensor data and the reverse stroke sensor data based on a change trend of sensor output values in the sensor data set includes: determining, from the sensor data set, sensor data whose sensor output values are within an increasing interval as the forward stroke sensor data; and determining, from the sensor data set, sensor data whose sensor output values are within a decreasing interval as the reverse stroke sensor data.

In one or more embodiments, the determining, from the sensor data set, the forward stroke sensor data and the reverse stroke sensor data based on a change trend of sensor output values in the sensor data set includes: determining, from the sensor data set, sensor data whose sensor output values are within an increasing interval as the reverse stroke sensor data; and determining, from the sensor data set, sensor data whose sensor output values are within a decreasing interval as the forward stroke sensor data.

In one or more embodiments, the determining, based on each of the N sensor input sampling values, a sensor output sampling value corresponding to the sensor input sampling value in the sensor data set, to obtain N sampling data includes: determining, based on each of the N sensor input sampling values, a forward stroke sensor output sampling value and a reverse stroke sensor output sampling value corresponding to each of the N sensor input sampling values in the sensor data set, to obtain N positive stroke sampling data and N reverse stroke sampling data, where the forward stroke sensor output sampling value is a forward stroke sensor output value corresponding to a forward stroke sensor input value adjacent to the sensor input sampling value in the sensor data set, and the reverse stroke sensor output sampling value is a reverse stroke sensor output value corresponding to a reverse stroke sensor input value adjacent to the sensor input sampling value in the sensor data set.

In one or more embodiments, a minimum value and a maximum value of the N sensor input sampling values are a minimum value and a maximum value of a sensor range, respectively.

In one or more embodiments, differences between each two adjacent sensor input sampling values in the N sensor input sampling values are equal to each other.

In a second aspect, embodiments of the present disclosure provides a sensor data processing apparatus, including a sensor data set acquisition module, a sensor input sampling value determination module, and a sampling data acquisition module. The sensor data set acquisition module is configured to acquire a sensor data set, and the sensor data set includes M pieces of sensor data, each of which includes a sensor input value and a sensor output value. The sensor input sampling value determination module is configured to determine N sensor input sampling values, and M>N>1. The sampling data acquisition module is configured to determine, based on each of the N sensor input sampling values, a sensor output sampling value corresponding to the sensor input sampling value in the sensor data set, to obtain N sampling data. The sensor output sampling value is the sensor output value corresponding to the sensor input value adjacent to the sensor input sampling value in the sensor data set.

In a third aspect, embodiments of the present disclosure provide an electronic device, including a processor, a memory, and a computer program stored in the memory. The computer program includes instructions, and when the instructions are executed by the processor, the electronic device executes the method according to any one method according to the first aspect.

In a fourth aspect, embodiments of the present disclosure provide a computer-readable storage medium including a program stored on the computer-readable storage medium, and when the program is executed, a device where the computer-readable storage medium is located is controlled to execute the method according to any one method according to the first aspect.

In the embodiments of the present disclosure, the sensor data processing apparatus acquires a sensor data set and determines N sensor input sampling values. In addition, the sensor data processing apparatus determines, based on each sensor input sampling value, the sensor output sampling value corresponding to the sensor input sampling value in the sensor data set, to obtain N sampling data. Such process does not involve complex manual operations, so that the final determined N sampling data have high accuracy, and the determination process of N sampling data is highly efficient.

### BRIEF DESCRIPTION OF DRAWINGS

In order to better illustrate technical solutions of embodiments of the present disclosure, the accompanying drawings used in embodiments will be briefly described below. The drawings described below are merely a part of the embodiments of the present disclosure. For ordinary technicians in this field, other drawings can be obtained based on these drawings without creative efforts.

FIG. 1 is a schematic diagram of an application scenario of an EPS provided by the related art.

FIG. 2 is a flow chart of a sensor data processing method provided by embodiments of the present disclosure.

FIG. 3 is a schematic diagram of an application scenario of a sensor data processing apparatus provided by the related art.

FIG. 4 is a flow chart of another sensor data processing method provided by embodiments of the present disclosure.

FIG. 5 is a schematic diagram of a sensor data processing apparatus provided by embodiments of the present disclosure.

FIG. 6 is a schematic diagram of another sensor data processing apparatus provided by embodiments of the present disclosure.

FIG. 7 is a schematic diagram of an electronic device provided by embodiments of the present disclosure.

### DESCRIPTION OF EMBODIMENTS

In order to understand the technical solutions of the present disclosure, the embodiments of the present disclosure are described in details with reference to the drawings.

It should be clear that the described embodiments are merely a part of the embodiments of the present disclosure rather than all of the embodiments. Based on the embodiments of the present disclosure, all other embodiments obtained by ordinary technicians in this field without creative efforts shall fall within the protection scope of the present disclosure.

The terms used in the embodiments of the present disclosure are only for the purpose of describing specific embodiments and are not intended to limit the present disclosure. The singular forms of “a/an”, “the” and “said” used in the embodiments of the present disclosure and the appended claims are also intended to include the plural forms, unless the context clearly indicates other meanings.

It should be understood that the term “and/or” used in this article is only a description of the association relationship of the associated objects, indicating that there may be three relationships. For example, A and/or B can include: A alone, A and B, and B alone. In addition, the character “/” in this article generally indicates that the associated objects are in an “or” relationship.

The electric power steering system is a power steering system that directly relies on the motor to provide auxiliary torque. During the actual use of the vehicle, each sensor collects the steering wheel torque and steering wheel angle applied by the driver to the steering wheel, and transmits the steering wheel angle to the EPS. EPS calculates the power torque based on the steering wheel torque and steering wheel angle and converts it into a current command for the power motor, and controls the power motor to generate the corresponding power torque. After the power torque is amplified by the gear reduction mechanism, it acts on the steering gear. Ultimately, it helps the driver overcome the steering resistance torque and enables the vehicle to turn.

For ease of understanding, a detailed description will be provided in conjunction with the accompanying drawings and specific embodiments.

FIG. 1 is a schematic diagram of an application scenario of an EPS provided by the relevant art. As shown in FIG. 1, in this application scenario, a steering wheel 101, an electronic power steering system 102, a steering shaft 103, a rack and pinion steering gear 104, and a tire 105 are illustrated. The electronic power steering system 102 includes an electronic control unit (ECU) 1021, a sensor 1022, a power motor 1023, and a gear reduction mechanism 1024.

As shown in FIG. 1, the steering wheel 101 controls a turning direction of the tire 105 through the steering shaft 103 and the rack and pinion steering gear 104, the sensor 1022 is configured to collect a sensor signal of the steering shaft 103, the ECU 1021 outputs a corresponding power motor control instruction according to a received sensor signal, and the power motor 1023 applies an auxiliary torque to the steering shaft 103 through powering the gear reduction mechanism 1024 to assist the steering shaft 103 to rotate.

In an actual application process, when the driver turns the steering wheel 101, the steering wheel 101 drives the steering shaft 103 to rotate, and the sensor 1022 transmits the collected sensor signal of the steering shaft 103 to the ECU 1021. The ECU 1021 controls the power motor 1023 to drive the gear reduction mechanism 1024 to rotate according to the received sensor signal, and then assists the steering shaft 103 to rotate, and finally drives the rack and pinion steering gear 104 to control the turning direction of the tire.

It is noted that FIG. 1 is only an exemplary illustration of the application scenario involved in the embodiments of the present disclosure, and it should not be used as a limitation on the protection scope of the present disclosure. It can be understood that the sensor 1022 is only an exemplary description. The sensor 1022 can be a torque sensor, an angle sensor, or a torque and angle sensor (the torque and angle sensor is a combination of a torque sensor and an angle sensor). In the present disclosure, there is no limitation on sensor types.

It can be understood that as one of the key devices of the electronic power steering system, the performance of the sensor directly determines the performance of the electronic power steering system, so it is necessary to perform relevant analysis on the performance of the sensor. In general, the performance of the sensor is analyzed according to a correspondence curve between sensor input values and sensor output values. In order to determine the correspondence curve between the sensor input values and the sensor output values, it is necessary to determine a correspondence data set including the sensor input values and the sensor output values.

In the related art, after the sensor output waveform and the sensor input waveform are received and related processing are performed on them, a sensor data set including a group of sensor output values and sensor input values can be determined. The sensor data set is organized into a table, and the sensor input values and the corresponding sensor output values are sorted. Next, N sensor input values and their corresponding sensor output values are evenly selected, and N sampling data are finally determined.

For example, when the sensor to be performed a performance test is an angle sensor, the organized sensor data set is shown in Table 1. Understandably, 6 sensor input values and their corresponding sensor output values are evenly selected as (0°, 0.1°), (179.5°, 180.2°), (360°, 360.8°), . . . , and (1080.4°, 1079.6°) to form 6 sampling data. The N sampling data are expressed in the form of coordinate points, with the angle sensor input value on the left and the angle sensor output value on the right, that is, (sensor input value, sensor output value).

TABLE 1

| Angle sensor input value | Angle sensor output value |
|---|---|
| 0° | 0.1° |
| 10.1° | 9.8° |
| 20.3° | 20.1° |
| . . . | . . . |
| 179.5° | 180.2° |
| . . . | . . . |
| 360° | 360.8° |
| . . . | . . . |
| 1080.4° | 1079.6° |

In some embodiments, those skilled in the art can uniformly select other numbers of sensor input values and their corresponding sensor output values to form the N sampling data according to actual needs. For example, when a high precision of a fitted correspondence curve between sensor input values and sensor output values is required, more sensor input values and their corresponding sensor output values can be selected to form the N sampling data. When the operation ability of the sensor data processing apparatus is poor and a high efficiency is required, fewer sensor input values and their corresponding sensor output values can be selected to form the N sampling data, which is not limited in the present disclosure.

However, by organizing the sensor data set into a table and sorting it, and manually selecting N sensor input values and their corresponding sensor output values, the precision of the determined N sampling data may be low, and the process of determining the N sampling data may be inefficient.

In view of the above problems, in the embodiments of the present disclosure, the sensor data processing apparatus acquires a sensor data set and determines N sensor input sampling values. In addition, the sensor data processing apparatus determines, based on each sensor input sampling value, the sensor output sampling value corresponding to the sensor input sampling value in the sensor data set, to obtain N sampling data. Such process does not involve complex manual operations, so that the final determined N sampling data have high accuracy, and the process of determining N sampling data is highly efficient. Next, it will be described in detail in conjunction with the accompanying drawings and embodiments.

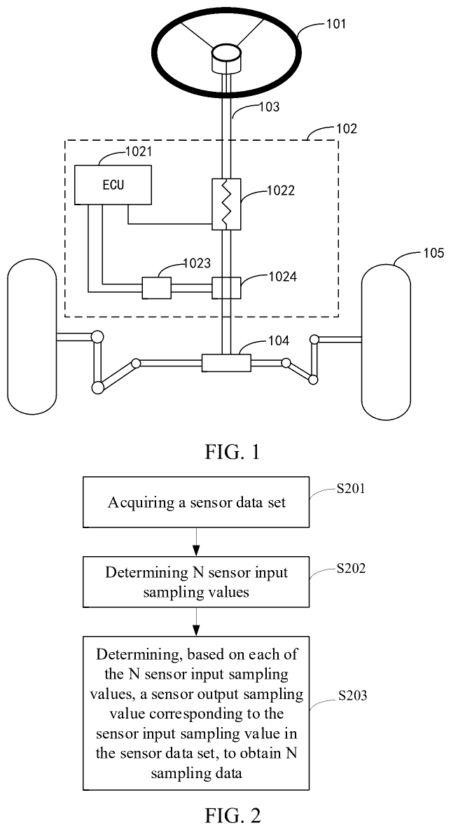

FIG. 2 is a flow chart of a sensor data processing method provided in some embodiments of the present disclosure. As shown in FIG. 2, the sensor data processing method includes following steps.

At step S201, a sensor data set is acquired.

In the embodiments of the present disclosure, a sensor data processing apparatus acquires a sensor data set including M pieces of sensor data, and each sensor data includes a sensor input value and a sensor output value. It can be understood that the sensor data set includes M sensor input values and sensor output values respectively corresponding to the sensor input values.

In actual application, the sensor data processing apparatus receives a sensor original data set, so it is also necessary to perform relevant processing on the sensor original data set before obtaining the sensor data set. In order to describe more clearly, the present disclosure also provides an application scenario of a sensor data processing apparatus. Next, it will be described in detail in conjunction with the accompanying drawings and specific embodiments.

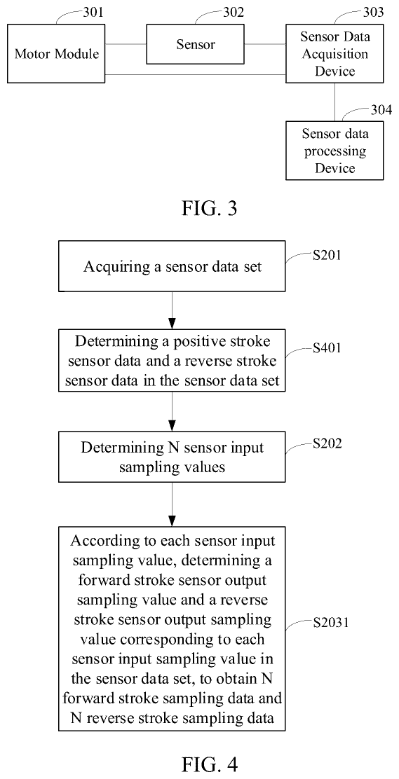

FIG. 3 is a schematic diagram of an application scenario of a sensor data processing apparatus provided by the related technologies. FIG. 3 illustrates a motor module 301, a sensor 302, a sensor data acquisition device 303, and a sensor data processing apparatus 304. The motor module 301 is electrically connected to the sensor data acquisition device 303, the sensor 302 is configured to collect the motor module 301, the sensor 302 is electrically connected to the sensor data acquisition device 303, and the sensor data acquisition device 303 is electrically connected to the sensor data processing apparatus 304.

In actual application, the sensor collects the relevant actions of the motor module and outputs the collected sensor output signal. The sensor data acquisition device receives the sensor output signal output by the sensor and the sensor input signal transmitted by the motor module. The sensor data acquisition device receives the sensor input signal and the sensor output signal and performs relevant processing on the sensor input signal and the sensor output signal to generate sensor original input data and sensor original output data corresponding to the sensor input signal and the sensor output signal respectively, and then transmits the generated sensor original input data and the generated sensor original output data, that is, the sensor original data set, to the sensor data processing apparatus. The sensor data processing apparatus obtains the sensor data set according to the sensor original data set.

It should be pointed out that the sensor output signal and the sensor input signal are generally pulse width modulation (PWM) signals, and the sensor original data set includes the sensor original input data and the sensor original output data that are in correspondence. Understandably, the sensor output signal and the sensor input signal are analog signals, and the sensor original input data and the sensor original output data are digital signals. It can be understood that in this case, “sensor original input data” and “sensor original output data” are intermediate quantities, and their units are not corresponding torque units or angle units. Therefore, the sensor data processing apparatus will perform relevant processing on the sensor original data set to obtain the sensor data set.

In some other embodiments, the sensor data acquisition device transmits the processed sensor data set to the sensor data processing apparatus, which is not limited in the present disclosure.

In some embodiments, the sensor corresponding to the “sensor data set” mentioned above may be a torque and angle sensor. Alternatively, it can also be a torque sensor or an angle sensor, which is not limited in the present disclosure.

At step S202, N sensor input sampling values are determined.

In the embodiments of the present disclosure, N sensor input sampling values are determined, where M>N>1.

It is appreciated that the number of determined sensor input sampling values is smaller than the number of sensor input values or sensor output values in the sensor data set. This is because when the number of sensor input sampling values is greater than the number of sensor input values or sensor output values in the sensor data set, it is inevitable that, among the data determined based on the sensor input sampling values, different sensor input sampling values will correspond to a same sensor output value, which leads to a lower accuracy of the determined N sampling data, and thus affects the performance analysis of the sensor.

In some embodiments, six sensor input sampling values are determined. Alternatively, those skilled in the art can determine other numbers of sensor input sampling values according to actual needs. For example, when the precision requirement for the fitted correspondence curve is high, more sensor input sampling values can be selected. When the operation ability of the sensor data processing apparatus is low and the efficiency requirement is high, fewer sensor input sampling values can be selected, which is not limited in the present disclosure.

In some embodiments, N sensor input sampling values are determined in response to relevant operations triggered by the user. It is understood that the user can input N sensor input sampling values into the sensor data processing apparatus. For example, the user can input six torque sensor input sampling values, namely 0 N·M, 3 N·M, 6 N·M, 9 N·M, 12 N·M, and 15 N·M, into the sensor data processing apparatus. Optionally, the user can input seven angle sensor input sampling values, namely 0°, 180°, 360°, 540°, 720°, 900°, and 1080°, into the sensor data processing apparatus.

In some embodiments, the sensor input sampling values are pre-stored. After the sensor data processing apparatus acquires the sensor data set, pre-stored sensor input sampling values are determined according to the type of the sensor data set. For example, the pre-stored torque sensor output sampling values are 0 N·M, 3 N·M, 6 N·M, 9 N·M, 12 N·M, and 15 N·M, and the pre-stored angle sensor output sampling values are 0°, 180°, 360°, 540°, 720°, 900°, and 1080°. After the sensor data processing apparatus acquires the torque sensor data set, the pre-stored sensor input sampling values are determined as 0 N·M, 3 N·M, 6 N·M, 9 N·M, 12 N·M, and 15 N·M according to the type of the sensor data set. Similarly, after the sensor data processing apparatus acquires the angle sensor data set, the pre-stored sensor input sampling values are determined as 0°, 180°, 360°, 540°, 720°, 900°, and 1080° according to the type of the sensor data set.

In some embodiments, the minimum value and the maximum value of the N sensor input sampling values are the minimum value and the maximum value of the sensor range, respectively. For example, when the range of an angle sensor is [0°, 1080°], the minimum and maximum values of the determined N sensor input sampling values are 0° and 1080°, respectively. Similarly, when the range of a torque sensor is [0 N·M, 15 N·M], the minimum and maximum values of the determined N sensor input sampling values are 0 N·M and 15 N·M, respectively.

It can be understood that in the embodiments of the present disclosure, by setting the minimum and maximum values of the N sensor input sampling values to be the minimum and maximum values of the sensor range respectively, the data in the sensor data set can be obtained to the maximum extent, thereby making the data information contained in the determined N sampling data more comprehensive, and finally enabling the N sampling data better reflect the relevant performance of the sensor.

In some embodiments, the differences between each two adjacent sensor input sampling values in the N sensor input sampling values are equal, that is, the sensor input sampling values are evenly distributed. For example, when six torque sensor input sampling values are provided, they may be 0 N·M, 3 N·M, 6 N·M, 9 N·M, 12 N·M, and 15 N·M. Alternatively, when seven angle sensor input sampling values are provided, they may be 0°, 180°, 360°, 540°, 720°, 900°, and 1080°, which is not limited in this disclosure.

It can be understood that in the embodiments of the present disclosure, by evenly setting N sensor input sampling values, the determined N sampling data can carry more information in the sensor data set, thereby enabling the N sampling data better reflect the relevant performance of the sensor.

At step S203, according to each of the N sensor input sampling values, a sensor output sampling value corresponding to each of the N sensor input sampling values in the sensor data set is determined to obtain N sampling data.

In the embodiments of the present disclosure, the sensor data processing apparatus determines the sensor output sampling value corresponding to each sensor input sampling value in the sensor data set according to each sensor input sampling value, and obtains N sampling data. The sensor output sampling value is the sensor output value corresponding to the sensor input value adjacent to the sensor input sampling value in the sensor data set.

It can be understood that when there is a sensor input value identical to the sensor input sampling value in the sensor data set, the determined sensor output sampling value is the sensor output value corresponding to the sensor input sampling value identical to the sensor input sampling value in the sensor data set. When there is no sensor input value identical to the sensor input sampling value in the sensor data set, the sensor output value corresponding to the sensor input value adjacent to the sensor input sampling value in the sensor data set is taken as the sensor output sampling value according to its magnitude.

It should be pointed out that, in general, when there is no sensor input value identical to the sensor input sampling value in the sensor data set, and each sensor input sampling value is adjacent to two sensor input values, in some embodiments, the sensor output value corresponding to the sensor input value more adjacent to the sensor input sampling value of the two sensor input values is taken as the sensor output sampling value.

Exemplarily, when there is no sensor input value identical to the sensor input sampling value in the sensor data set, the sensor input sampling value is 180°, and the two sensor input values adjacent to the sensor input sampling value are 180.1° and 179.8° according to its magnitude, and the sensor output value corresponding to the sensor input value of 180.1° is selected as the sensor output sampling value.

It can be understood that the “sampling data” includes a sensor input sampling value and a sensor output sampling value corresponding to the sensor input sampling value. With the sensor data processing method described above, i.e., step S201 to step S203, N sampling data can be finally obtained. The N sampling data is a group of sample sampling data.

In some embodiments, in order to ensure that the sensor has more accurate sample sampling data, the sensor data processing method is often repeated multiple times, that is, step S201 to step S203 are performed for 3 to 5 cycles, so that 3 to 5 sample sampling data can be determined. It can be understood that by performing an average calculation on the 3 to 5 sample sampling data, the determined sample sampling data has higher accuracy.

In embodiments of the present disclosure, a sensor data processing apparatus acquires a sensor data set and determines N sensor input sampling values. In addition, the sensor data processing apparatus determines the sensor output sampling value corresponding to each sensor input sampling value in the sensor data set based on each sensor input sampling value, and then acquires N sampling data. Such process does not involve complex manual operations, so that the final determined N sampling data have high accuracy, and the process of determining the N sampling data is highly efficient.

In actual practice, since it is necessary to distinguish a positive stroke and a reverse stroke when analyzing the relevant performance of the sensor, it is necessary to obtain forward stroke sensor data and reverse stroke sensor data. In embodiments of the present disclosure, in order to obtain forward stroke sensor data and reverse stroke sensor data, after obtaining the sensor data set, the sensor data set can be divided into forward stroke sensor data and reverse stroke sensor data according to relevant rules. Next, it will be described in detail in conjunction with the accompanying drawings and specific embodiments.

It can be understood that, taking the angle sensor collecting the angle information of the steering wheel as an example, the positive stroke refers to the process of controlling the steering wheel to turn left or right from the original position, and the reverse stroke refers to the process of controlling the steering wheel to return to the original position. The original position refers to the position corresponding to the steering wheel when the vehicle is traveling in a straight line.

FIG. 4 is a flow chart of another sensor data processing method provided in some embodiments of the present disclosure. As shown in FIG. 4, on the basis of FIG. 2, the sensor data processing method also includes following step S401.

At step S401, the forward stroke sensor data and the reverse stroke sensor data in the sensor data set are determined.

In the embodiments of the present disclosure, after obtaining the sensor data set, the forward stroke sensor data and the reverse stroke sensor data in the sensor data set are determined. For example, after obtaining the sensor data set, the forward stroke sensor data and the reverse stroke sensor data in the sensor data set are determined according to a change trend of the sensor output value in the sensor data set.

In some embodiments, the sensor data in the sensor data set whose sensor output values are within an increasing interval is determined as the forward stroke sensor data, and the sensor data in the sensor data set whose sensor output values are within a decreasing interval is determined as the reverse stroke sensor data. For example, in the embodiments of the present disclosure, after a sensor output value is obtained, the obtained sensor output value this time is compared with the sensor output value obtained last time. When the obtained sensor output value this time is greater than the sensor output value obtained last time, the sensor output value obtained this time and its corresponding sensor input value are forward stroke sensor data. When the obtained sensor output value this time is smaller than the sensor output value obtained last time, the sensor output value obtained this time and its corresponding sensor input value are reverse stroke sensor data.

It can be understood that, in general, a waveform formed by the sensor output values over time is similar to a sine wave. A moment when a valley value of the sensor output values is identified is a beginning of the positive stroke. A moment when a peak value of the sensor output values is identified is a beginning of the reverse stroke. Exemplarily, the peak value of the sensor output value is A, and the valley value of the sensor output value is B. When it is identified that the sensor output value is A and determined that the next sensor output value is smaller than A, it is determined that the reverse stroke begins, and in this case, the determined sensor output value and the sensor input value corresponding to the sensor output value are the reverse stroke sensor data. When it is identified that the sensor output value is B and determined that the next sensor output value is greater than B, it is determined that the positive stroke begins, and in this case, the determined sensor output value and the sensor input value corresponding to the sensor output value are forward stroke sensor data.

It can be understood that the peak value and valley value correspond to the maximum and minimum values of the full-scale range output values of the sensor, respectively. It should be pointed out that since the waveform of the sensor output values over time is actually formed by digital signals, there may be no valley value and peak value in a process of mutual conversion between the positive stroke and the reverse stroke. Therefore, a first preset value adjacent to the maximum value of the full-scale range output values of the sensor can be set, and a second preset value adjacent to the minimum value of the full-scale range output values of the sensor can be set. For example, when the peak value of the sensor output values is 6° and the valley value of the sensor output values is −6°, the first preset value may be set to 5.8° and the second preset value may be set to −5.8°.

In some embodiments, when it is identified that the sensor output value is the first preset value or greater than the first preset value, it is determined whether the next sensor output value is smaller than the sensor output value at this moment. When the next sensor output value is smaller than the sensor output value at this moment, it is determined that the reverse stroke starts, and the determined sensor output value at this moment and the sensor input value corresponding to the sensor output value are the reverse stroke sensor data. When it is identified that the sensor output value is the second preset value or smaller than the second preset value, it is determined whether the next sensor output value is greater than the sensor output value at this moment. When the next sensor output value is greater than the sensor output value at this time, it is determined that the positive stroke starts, and the sensor output value determined at this moment and the sensor input value corresponding to the sensor output value are the forward stroke sensor data.

In some other embodiments, the sensor data in the sensor data set whose sensor output values are within a decreasing interval is determined as the forward stroke sensor data, and the sensor data in the sensor data set whose sensor output values are within an increasing interval is determined as the reverse stroke sensor data. For example, in the embodiments of the present disclosure, after obtaining a sensor output value, the obtained sensor output value this time is compared with the sensor output value obtained last time. When the obtained sensor output value this time is greater than the sensor output value obtained last time, the sensor output value obtained this time and its corresponding sensor input value are reverse stroke sensor data. When the obtained sensor output value this time is smaller than the sensor output value obtained last time, the sensor output value obtained this time and its corresponding sensor input value are forward stroke sensor data.

It can be understood that, in general, the waveform of the sensor output value over time is similar to a sine wave. A moment when the valley value of the sensor output value is identified is a beginning of the reverse stroke, a moment when the peak value of the sensor output value is identified is a beginning of the positive stroke. Exemplarily, the peak value of the sensor output value is A, and the valley value of the sensor output value is B. When it is identified that the sensor output value is A and determined that the next sensor output value is smaller than A, it is determined that the positive stroke starts, and the determined sensor output value at this moment and the sensor input value corresponding to the sensor output value are the forward stroke sensor data. When it is identified that the sensor output value is B and determined that the next sensor output value is greater than B, it is determined that the reverse stroke starts, and the determined sensor output value at this moment and the sensor input value corresponding to the sensor output value are the reverse stroke sensor data.

It can be understood that the peak value and the valley value correspond to the maximum and minimum values of the full-scale range output values of the sensor, respectively. It should be pointed out that since the waveform of the sensor output values over time is actually formed by digital signals, there may be no valley value and peak value in the process of mutual conversion between the positive stroke and the reverse stroke. Therefore, a first preset value adjacent to the maximum value of the full-scale range output values of the sensor can be set, and a second preset value adjacent to the minimum value of the full-scale range output values of the sensor can be set. For example, when the peak value of the sensor output values is 6° and the valley value of the sensor output values is −6°, the first preset value may be set to 5.8°, and the second preset value may be set to −5.8°.

In some embodiments, when it is identified that the sensor output value is the first preset value or greater than the first preset value, it is determined whether the next sensor output value is smaller than the sensor output value at this moment. When the next sensor output value is smaller than the sensor output value at this moment, it is determined that the positive stroke starts at this moment, and the determined sensor output value at this moment and the sensor input value corresponding to the sensor output value are the forward stroke sensor data. When it is identified that the sensor output value is the second preset value or smaller than the second preset value, it is determined whether the next sensor output value is greater than the sensor output value at this moment. When the next sensor output value is greater than the sensor output value at this moment, it is determined that the reverse stroke starts at this moment, and the sensor output value determined at this moment and the sensor input value corresponding to the sensor output value are the reverse stroke sensor data.

As shown in FIG. 4, based on FIG. 2, step S203 includes the following step S2031.

At step S2031, based on each of the N sensor input sampling values, a forward stroke sensor output sampling value and a reverse stroke sensor output sampling value corresponding to each of the N sensor input sampling values in the sensor data set are determined, to obtain N positive stroke sampling data and N reverse stroke sampling data.

In the embodiment of the present disclosure, the sensor data processing apparatus determines the forward stroke sensor output sampling value and the reverse stroke sensor output sampling value corresponding to each sensor input sampling value in the sensor data set according to each sensor input sampling value, and obtains N positive stroke sampling data and N reverse stroke sampling data. The forward stroke sensor output sampling value is the forward stroke sensor output value corresponding to the forward stroke sensor input value adjacent to the sensor input sampling value in the sensor data set, and the reverse stroke sensor output sampling value is the reverse stroke sensor output value corresponding to the reverse stroke sensor input value adjacent to the sensor input sampling value in the sensor data set. The specific process refers to the above method step S203, which is not elaborated further for the sake of brevity.

Corresponding to the above embodiments, the present disclosure also provides a sensor data processing apparatus.

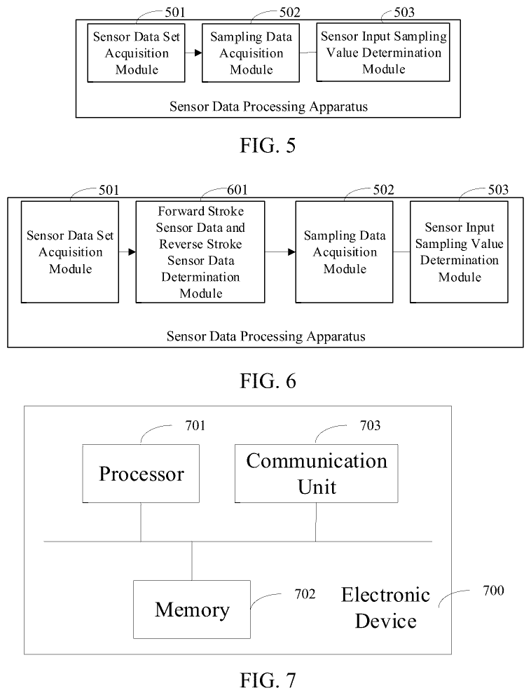

FIG. 5 is a schematic diagram of a sensor data processing apparatus provided in some embodiments of the present disclosure. In FIG. 5 a sensor data set acquisition module 501, a sensor input sampling value determination module 503, and a sampling data acquisition module 502 are illustrated. The sampling data acquisition module 502 is electrically connected to the sensor data set acquisition module 501, and the sampling data acquisition module 502 is electrically connected to the sensor input sampling value determination module 503.

In the embodiments of the present disclosure, the sensor data set acquisition module is configured to acquire a sensor data set, and the sensor data set includes M pieces of sensor data, each of which includes a sensor input value and a sensor output value. The sensor input sampling value determination module is configured to determine N sensor input sampling values, where M>N>1. The sampling data acquisition module is configured to determine a sensor output sampling value corresponding to each sensor input sampling value in the sensor data set according to each sensor input sampling value, to obtain N sampling data. The sensor output sampling value is the sensor output value corresponding to the sensor input value adjacent to the sensor input sampling value in the sensor data set. The specific content involved in the embodiments of the present disclosure can be referred to the description of the above method embodiments, which is not elaborated further for the sake of brevity.

FIG. 6 is a schematic diagram of another sensor data processing apparatus provided in some embodiments of the present disclosure. As shown in FIG. 6, on the basis of the sensor data processing apparatus shown in FIG. 5, the sensor data processing apparatus further includes a forward stroke sensor data and reverse stroke sensor data determination module 601. The forward stroke sensor data and reverse stroke sensor data determination module 604 is electrically connected to the sensor data set acquisition module 501, and is also electrically connected to the sampling data acquisition module 502.

In some embodiments of the present disclosure, the forward stroke sensor data and reverse stroke sensor data determination module is configured to determine the forward stroke sensor data and reverse stroke sensor data in the sensor data set. For example, the forward stroke sensor data and reverse stroke sensor data determination module is configured to determine the forward stroke sensor data and reverse stroke sensor data in the sensor data set according to a change trend of the sensor output values in the sensor data set.

In some embodiments, the forward stroke sensor data and reverse stroke sensor data determination module is configured to determine sensor data in the sensor data set whose sensor output values are within an increasing interval as a forward stroke sensor data, and is also configured to determine sensor data in the sensor data set whose sensor output values are within a decreasing interval as the reverse stroke sensor data.

In some other embodiments, the forward stroke sensor data and reverse stroke sensor data determination module is configured to determine sensor data in the sensor data set whose sensor output values are within an increasing interval as a reverse stroke sensor data, and is also configured to determine sensor data in the sensor data set whose sensor output values are in a decreasing interval as the forward stroke sensor data.

In the embodiment of the present disclosure, the sampling data acquisition module is also configured to determine the forward stroke sensor output sampling value and the reverse stroke sensor output sampling value corresponding to each sensor input sampling value in the sensor data set according to each sensor input sampling value, to obtain N positive stroke sampling data and N reverse stroke sampling data. The forward stroke sensor output sampling value is the forward stroke sensor output value corresponding to the forward stroke sensor input value adjacent to the sensor input sampling value in the sensor data set. The reverse stroke sensor output sampling value is the reverse stroke sensor output value corresponding to the reverse stroke sensor input value adjacent to the sensor input sampling value in the sensor data set. The specific contents involved in the embodiments of the present disclosure can be referred to the description of the above method embodiments, which is not elaborated further for the sake of brevity.

Corresponding to the above embodiments, the present disclosure also provides an electronic device.

FIG. 7 is a schematic diagram of an electronic device provided in some embodiments of the present disclosure. The electronic device 700 may include a processor 701, a memory 702, and a communication unit 703. These components communicate through one or more buses. Those skilled in the art will understand that the structure of the electronic device shown in the figure does not limit the embodiments of the present disclosure. It can be a bus structure or a star structure, and can also include more or fewer components than the structure shown in the figure, or combine certain components, or arrange components differently.

The communication unit 703 is configured to establish a communication channel so that the electronic device can communicate with other devices, to receive user data transmitted by other devices, or transmit user data to other devices.

The processor 701 is a control center of the electronic device, utilizes various interfaces and lines to connect various parts of the entire electronic device, and executes or performs software programs, instructions, and/or modules stored in the memory 702, and calls data stored in the memory to execute various functions of the electronic device and/or process data. The processor can be composed of an integrated circuit (IC), for example, it can include a single packaged IC, or it can include multiple packaged ICs with the same or different functions. For example, the processor 701 may include only a central processing unit (CPU). In some embodiments, the CPU may be a single computing core or may include multiple computing cores.

The memory 702 is configured to store the execution instructions of the processor 701. The memory 702 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or an optical disk.

When the execution instructions in the memory 702 are executed by the processor 701, the electronic device 700 is enabled to execute some or all of the steps in the embodiments shown in FIG. 1.

In some embodiments, the present disclosure also provides a computer storage medium, the computer storage medium may store a program, and when the program is executed, it may include some or all of the steps in each embodiment of the sensor data processing method provided by the present disclosure. The storage medium may be a disk, an optical disk, a read-only memory (ROM) or a random access memory (RAM), etc.

In the embodiments of the present disclosure, “at least one” indicates one or more, and “multiple” indicates two or more. “And/or” describes the association relationship of the associated objects, indicating three relationships. For example, A and/or B may indicate A alone, A and B, and B alone. A and B may be in a singular or plural form. The character “/” generally indicates that the associated objects are in an “or” relationship. “At least one of the following” and similar expressions refers to any combination of these items, including any combination of single or plural items. For example, at least one of a, b, or c may indicate a, b, c, a and b, a and c, b and c, or a, b and c, where a, b, c may be in a single or plural form.

A person skilled in the art may realize that the units and algorithm steps described in the embodiments disclosed herein may be implemented by electronic hardware, computer software, or a combination of computer software and electronic hardware. Whether these functions are performed in hardware or software depends on the specific application and design constraints of the technical solution. Professional technicians can use different methods to implement the described functions for each specific application, but such implementation should not be regarded as being beyond the scope of the present disclosure.

Those skilled in the art can clearly understand that for the convenience and simplicity of description, the specific working process of the systems, devices and units described above can refer to the corresponding process in the aforementioned method embodiments, which is not elaborated further.

In several embodiments provided in the present disclosure, if any function is implemented in the form of a software functional unit to sell or use as an independent product, it can be stored in a computer-readable storage medium. Based on such understanding, the technical solution of the present disclosure essentially or the part that contributes to the prior art or the part of the technical solution can be embodied in the form of a software product, and the computer software product is stored in a storage medium, including a number of instructions to enable a computer device (which can be a personal computer, a server, or a network device, etc.) to perform all or some of the steps of the method described in each embodiment of the present disclosure. The aforementioned storage medium includes U disk, mobile hard disk, read-only memory (ROM), random access memory (RAM), disk or optical disk, etc., various media that can store program codes.

In the present specification, the same or similar parts between the various embodiments can be referred to each other. For the device embodiments, since they are basically similar to the method embodiments, the description is relatively simple, and the relevant parts can be referred to the description in the method embodiments.

What is claimed is:

1. A sensor data processing method, comprising:
acquiring a sensor data set, wherein the sensor data set comprises M pieces of sensor data, and each of the M pieces of sensor data comprises a sensor input value and a sensor output value;
determining N sensor input sampling values, wherein M>N>1; and
determining, based on each of the N sensor input sampling values, a sensor output sampling value corresponding to each of the N sensor input sampling values in the sensor data set, to obtain N sampling data, wherein the sensor output sampling value is the sensor output value corresponding to the sensor input value adjacent to the sensor input sampling value in the sensor data set.

2. The sensor data processing method according to claim 1, subsequent to acquiring the sensor data set, further comprising:
determining, from the sensor data set, forward stroke sensor data and reverse stroke sensor data.

3. The sensor data processing method according to claim 2, wherein said determining, from the sensor data set, forward stroke sensor data and reverse stroke sensor data comprises:
determining, from the sensor data set, the forward stroke sensor data and the reverse stroke sensor data based on a change trend of sensor output values in the sensor data set.

4. The sensor data processing method according to claim 3, wherein said determining, from the sensor data set, the forward stroke sensor data and the reverse stroke sensor data based on a change trend of sensor output values in the sensor data set comprises:
determining, from the sensor data set, sensor data whose sensor output values are within an increasing interval as the forward stroke sensor data; and
determining, from the sensor data set, sensor data whose sensor output values are within a decreasing interval as the reverse stroke sensor data.

5. The sensor data processing method according to claim 3, wherein said determining, from the sensor data set, the forward stroke sensor data and the reverse stroke sensor data based on a change trend of sensor output values in the sensor data set comprises:
determining, from the sensor data set, sensor data whose sensor output values are within an increasing interval as the reverse stroke sensor data; and
determining, from the sensor data set, sensor data whose sensor output values are within a decreasing interval as the forward stroke sensor data.

6. The sensor data processing method according to claim 2, wherein said determining, based on each of the N sensor input sampling values, a sensor output sampling value corresponding to each of the N sensor input sampling values in the sensor data set, to obtain N sampling data comprises:
determining, based on each of the N sensor input sampling values, a positive stroke sensor output sampling value and a reverse stroke sensor output sampling value corresponding to each of the N sensor input sampling values in the sensor data set, to obtain N positive stroke sampling data and N reverse stroke sampling data, wherein the forward stroke sensor output sampling value is a forward stroke sensor output value corresponding to a forward stroke sensor input value adjacent to the sensor input sampling value in the sensor data set, and the reverse stroke sensor output sampling value is a reverse stroke sensor output value corresponding to a reverse stroke sensor input value adjacent to the sensor input sampling value in the sensor data set.

7. The sensor data processing method according to claim 3, wherein said determining, based on each of the N sensor input sampling values, a sensor output sampling value corresponding to each of the N sensor input sampling values in the sensor data set, to obtain N sampling data comprises:
determining, based on each of the N sensor input sampling values, a positive stroke sensor output sampling value and a reverse stroke sensor output sampling value corresponding to each of the N sensor input sampling values in the sensor data set, to obtain N positive stroke sampling data and N reverse stroke sampling data, wherein the forward stroke sensor output sampling value is a forward stroke sensor output value corresponding to a forward stroke sensor input value adjacent to the sensor input sampling value in the sensor data set, and the reverse stroke sensor output sampling value is a reverse stroke sensor output value corresponding to a reverse stroke sensor input value adjacent to the sensor input sampling value in the sensor data set.

8. The sensor data processing method according to claim 4, wherein said determining, based on each of the N sensor input sampling values, a sensor output sampling value corresponding to each of the N sensor input sampling values in the sensor data set, to obtain N sampling data comprises:
determining, based on each of the N sensor input sampling values, a positive stroke sensor output sampling value and a reverse stroke sensor output sampling value corresponding to each of the N sensor input sampling values in the sensor data set, to obtain N positive stroke sampling data and N reverse stroke sampling data, wherein the forward stroke sensor output sampling value is a forward stroke sensor output value corresponding to a forward stroke sensor input value adjacent to the sensor input sampling value in the sensor data set, and the reverse stroke sensor output sampling value is a reverse stroke sensor output value corresponding to a reverse stroke sensor input value adjacent to the sensor input sampling value in the sensor data set.

9. The sensor data processing method according to claim 5, wherein said determining, based on each of the N sensor input sampling values, a sensor output sampling value corresponding to each of the N sensor input sampling values in the sensor data set, to obtain N sampling data comprises:
determining, based on each of the N sensor input sampling values, a positive stroke sensor output sampling value and a reverse stroke sensor output sampling value corresponding to each of the N sensor input sampling values in the sensor data set, to obtain N positive stroke sampling data and N reverse stroke sampling data, wherein the forward stroke sensor output sampling value is a forward stroke sensor output value corresponding to a forward stroke sensor input value adjacent to the sensor input sampling value in the sensor data set, and the reverse stroke sensor output sampling value is a reverse stroke sensor output value corresponding to a reverse stroke sensor input value adjacent to the sensor input sampling value in the sensor data set.

10. The sensor data processing method according to claim 1, wherein a minimum value and a maximum value of the N sensor input sampling values are a minimum value and a maximum value of a sensor range, respectively.

11. The sensor data processing method according to claim 10, wherein differences between each two adjacent sensor input sampling values in the N sensor input sampling values are equal to each other.

12. An electronic device, comprising:
a processor;
a memory; and
a computer program stored in the memory, wherein the computer program comprises instructions, and when the instructions are executed by the processor, the electronic device executes a sensor data processing method, comprising:
acquiring a sensor data set, wherein the sensor data set comprises M pieces of sensor data, and each of the M pieces of sensor data comprises a sensor input value and a sensor output value;
determining N sensor input sampling values, wherein M>N>1; and
determining, based on each of the N sensor input sampling values, a sensor output sampling value corresponding to each of the N sensor input sampling values in the sensor data set, to obtain N sampling data, wherein the sensor output sampling value is the sensor output value corresponding to the sensor input value adjacent to the sensor input sampling value in the sensor data set.

13. A computer-readable storage medium, comprising a program stored on the computer-readable storage medium, wherein when the program is executed, a device where the computer-readable storage medium is located is controlled to execute a sensor data processing method, comprising:
acquiring a sensor data set, wherein the sensor data set comprises M pieces of sensor data, and each of the M pieces of sensor data comprises a sensor input value and a sensor output value;
determining N sensor input sampling values, wherein M>N>1; and
determining, based on each of the N sensor input sampling values, a sensor output sampling value corresponding to each of the N sensor input sampling values in the sensor data set, to obtain N sampling data, wherein the sensor output sampling value is the sensor output value corresponding to the sensor input value adjacent to the sensor input sampling value in the sensor data set.
